(19) United States
(12) Patent Application Publication
(10) Pub. No.: US 2012/0037669 A1
(43) Pub. Date: Feb. 16, 2012

(54) Dispenser

(76) Inventors: Hermann Goetz, Wiesbaden (DE); Dieter Folland, Hochheim (DE); Bruno Ackermann, Nieder-Olm (DE)

(21) Appl. No.: 13/255,562

(22) PCT Filed: Mar. 4, 2010
(86) PCT No.: PCT/EP2010/001337

§ 371 Date: Oct. 27, 2011

(30) Foreign Application Priority Data
Mar. 12, 2009 (DE) 20 2009 003 541.7

(51) Int. Cl. G01F 11/26; B65D 51/20; B65D 17/34

(52) U.S. Cl. 222/456; 220/253; 220/270

(57) ABSTRACT

A dispenser in which an outlet opening is provided in the container lid which is opened by tearing open a sealing membrane in order to open the container. A removal tube is connected to the outlet opening and extends to the container base in order to dispense a portion of goods at the outlet opening when the dispenser is tilted and the removal opening of a rotary slide lid is aligned with the outlet opening in the lid. The rotary slide lid may be rotated into a position in which the outlet opening in the lid is hermetically sealed.

### FIELD OF THE INVENTION

The invention relates to a dispensing container for liquid or flowable goods, comprising a container wall, a container base, a container lid having an outlet, and a removal insert for dispensing portions of goods from the dispensing container, and a method for handling the dispensing container.

### BACKGROUND OF THE INVENTION

Dispensing containers are known in the form of refillable sugar dispensers, and have a screw-on lid together with a central dispensing tube whose lower end projects into the container and which may be inclined. A portion of sugar may be removed by tipping the container, provided that the level in the container is above this portioning opening. However, it is not possible to completely empty the container.

A refillable measuring container having a conical shape is known from DE 26 01 491 A, having a channel with an outlet opening, which extends upwardly from the base of the container, for dispensing a powdered food product. A measuring cylinder having sector-shaped divisions is connected to the container in order to deliver a metered portion of dispensed goods to the channel when the container is tipped. In one exemplary embodiment, a closure cap having a discharge opening is provided above the outlet opening in the container, and may be aligned with the outlet opening in order to dispense goods. However, sealed storage of the goods without loss of flavor is not possible.

A refillable tilting container for dispensing a portion of goods is known from DE 201 06 891 U1, having two closure caps placed one inside the other, the upper cap being rotatable and being provided with a curved outlet tube, while the lower closure cap has an outlet opening which may be aligned with the outlet tube. To minimize interspaces, a sealing plate having an outlet opening is situated between the two closure caps; this outlet opening is aligned with the outlet opening in the lower closure cap, and therefore is not able to seal this outlet opening. Thus, sealed storage of goods is not possible.

A dispensing container having complete emptying of goods is known from WO 2006/125604 A1. The container wall is either cylindrical or has a basic four-sided polyhedral shape. In the case of a cylindrical dispensing container, an outlet is provided in the container lid, near the edge of the container wall, from which the removal insert extends to near the container base. Before the goods are used, the outlet is suitably closed by a lid, tear-off film, or the like, and is opened in order to remove the goods. However, there is no subsequent protection, for example evaporation protection or protection against penetration of atmospheric oxygen, after opening the container.

A container is known from US 2004/0256421 A1, having mutually alignable dispensing openings which are provided in an inner lid that is fixedly connected to the container, and in an outer, rotatable lid. The inner lid has an annular wall which is situated in the container opening in a sealing manner. The outer lid overlaps the inner lid and also the container neck, which has a detent rib which engages in a groove in the outer lid. The edge of the outer lid is formed by a tear-off tamper-evident band. The outlet opening in the inner lid is surrounded by a lip seal which cooperates with the underside of the outer lid in the closed position of the container. When the opening in the outer lid is rotated over the opening in the inner lid, goods may be poured from the container. However, metered dispensing of goods is not possible.

A dispensing container is known from U.S. Pat. No. 2,704,623 which is composed of a cylindrical container body, a screw-on lid, and a dispensing tube provided with a funnel. The funnel occupies the base of the container, and has radial slits which allow the goods to pass into the funnel, and thus into the dispensing tube. The screw-on lid has a central outlet opening which aligns with the outlet tube, a pour opening at the edge, and a group of sprinkling openings which communicate with the interior of the container outside the outlet tube and outside the funnel. A rotary disk having a dispensing opening is rotatably supported on the top side of the lid in order to overlap the dispensing opening with the central opening, or with the pour opening, or with the group of sprinkling openings, thus determining the manner in which the goods are dispensed. When the dispensing opening is not overlapped by an opening in the screw-on lid, a closed position of the dispensing container is achieved which, however, is not aroma-tight.

### SUMMARY OF THE INVENTION

It is an object of the invention to provide a dispensing container in the form of a dispenser which is fillable as originally manufactured.

A further object of the invention is to appropriately design the dispenser for the original filling using customary, existing automatic filling machines.

A further object of the invention is to ensure gas- and aroma-tight enclosure of the goods in the dispenser.

A further object of the invention is to be able to quickly close the dispensing container after removing goods from it.

According to yet a further object of the invention, the evaporation of the goods and the penetration of atmospheric oxygen into the container are largely avoided.

According to the invention, a dispenser is provided in which an outlet opening is provided in the container lid which is opened by pulling off a sealing membrane. A rotary slide lid having a removal opening is clipped onto the container lid and aligned with the outlet opening in the container lid. A portion of goods is dispensed by tilting the dispenser. The rotary slide lid is rotated into a position in which the outlet opening in the container lid is hermetically sealed.

In particular, the dispenser includes a container body, a container lid, a sealing membrane, a removal tube, a rotary slide lid, and optionally a tamper-proof seal. The container body has a container wall and a container base, and at the upper end is provided with an opening that is surrounded by a crimped edge. The container lid has a so-called lid panel which is surrounded by a crimped edge, and in which an outlet opening and optionally also a filling opening are provided. A tear-off tab of the sealing membrane may be pulled off from the outlet opening. The lower end of the removal tube has a removal funnel near the container base, and at the upper end is connected to the outlet opening in the container lid. The rotary slide lid has a removal opening which may be brought into and out of alignment with the outlet opening in the container lid by rotating the rotary slide lid. For this purpose, the rotary slide lid has a guide edge which cooperates with the interlocking ring, composed of the folded edges of the container body and the container lid, in the sense of a detent connection and a rotary guide. The rotary slide lid has a sealing collar which extends around the removal opening and which, depending on the design of the sealing membrane, rests on the lid panel or the sealing membrane in a sealing manner in order to close the dispenser in an aroma-tight manner in the closed position, and in the open position to allow the removal of goods via the removal tube, the outlet opening, the broken or removed sealing membrane, and the removal opening.

Further particulars of the invention result from the claims and the following description of exemplary embodiments in conjunction with the drawings.

### BRIEF DESCRIPTION OF THE DRAWINGS

FIG. 1 shows an exploded illustration of the individual parts of the dispenser according to a first embodiment,

FIG. 2 shows a cross section of a rotary slide lid along line I-I in FIG. 1,

FIG. 2a shows an enlarged detail from FIG. 2,

FIG. 3 shows a cross section of a sealing membrane along line II-II,

FIG. 3a shows an enlarged detail from FIG. 3,

FIG. 4 shows a cross section of a container lid according to line

FIG. 5 shows a cross section in the region of the container base and the removal tube,

FIG. 6 shows a second embodiment of the dispenser in an exploded illustration,

FIG. 7 shows a rotary slide lid according to section IV-IV,

FIG. 8 shows a container lid according to section V-V, and

FIG. 9 shows a cross section of the container base together with base filling closures.

### DETAILED DESCRIPTION

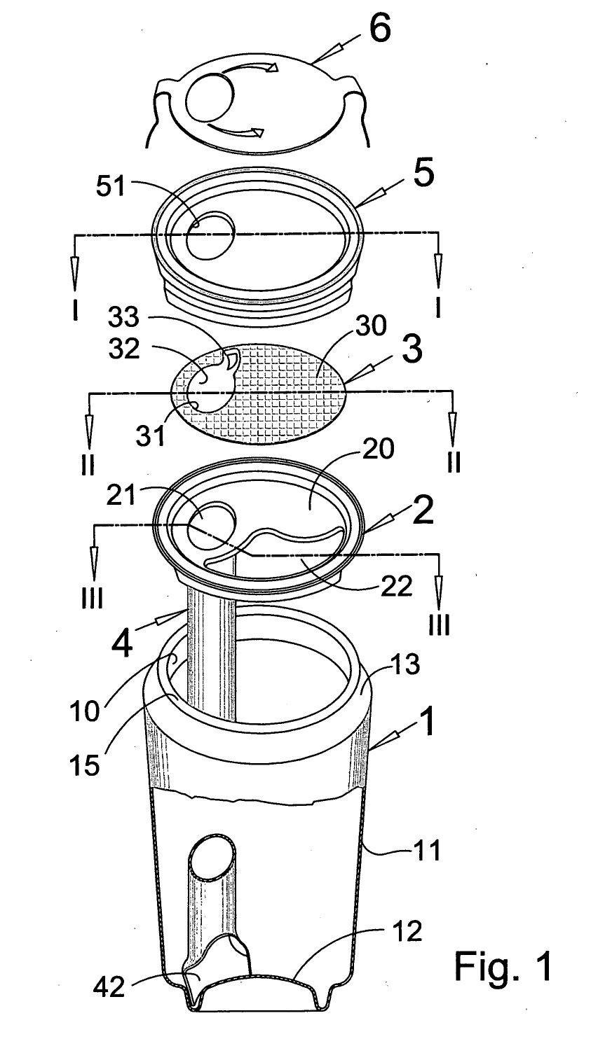

FIG. 1 shows the primary parts of the dispenser, namely, a container body 1, a container lid 2, a sealing membrane 3, a removal tube 4, and a rotary slide lid 5. The dispenser optionally also includes a tamper-proof seal 6. The removal tube 4 extends from the lid 2 to the container base. The container body 1 may have a one-part or multipart design.

In FIG. 1 the container body 1 is illustrated with a cylindrical container wall 11, a dome-shaped container base 12, and a neck 13 which has a crimped edge 15 that extends around an opening 10. As shown most clearly in FIG. 5, an integrally molded, ring-shaped protrusion 16 is provided in the container base 12 which serves multiple purposes: It is used as a standing surface for the container on a flat support surface, and in interaction with the rotary slide lid 5 is used as a stacking surface for containers stacked one on top of the other, and in addition, inside the container the protrusion 16 forms a guide groove 16a for cooperating with the lower end 42 of the removal tube 4, as explained below.

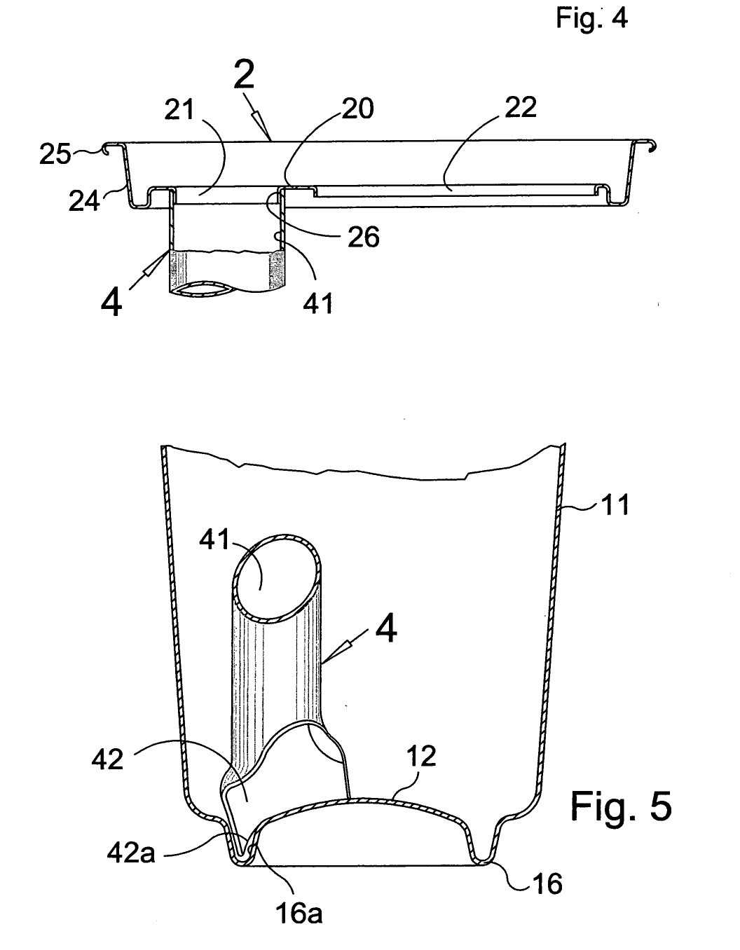

The container lid 2 (see FIGS. 1 and 4) is designed as an essentially flat, circular, press-punched sheet metal part having a flanged edge 24 and a topside lid panel 20 in which an outlet opening 21 and a circular segment-shaped filling opening 22 are provided. The outlet opening may have any desired cross-sectional shape, but preferably has an oval cross-sectional shape due to the fact that the removal tube, which likewise has an oval cross section, properly fits automatically with its lower end 42 in the groove 16a. The flanged edge 24 merges into a crimped edge 25. A sealing compound is applied to the flanged edge 24 of the container lid 2 in order to establish a gas-tight connection between the container lid 2 and the neck 13 of the container body 1 when the two folding edges 15, 25 are crimped together and form an interlocking ring 15/25. This interlocking ring locally projects with respect to the neck 13 of the container body, thus forming a ring-shaped shoulder as a detent stop and rotary guide for the rotary slide lid 5, as explained below.

FIG. 3 shows one possible embodiment of the sealing membrane 3 in cross section. A film base body 30 made of aluminum foil or plastic film is provided which conforms to the shape of the lid panel 20, in which a weakening line 31a (FIG. 3a) corresponding to the contour shape of the outlet opening 21 is located. A sealing layer is provided on the film base body 30 to allow a seal to be established at the lid 2. The weakening line 31a is obtained, for example, by prescoring the film base body 30 down to 8/10 of its thickness. The tear-off opening 31 (FIG. 1) prepared in this way is covered by a tear-off tab 32 which is welded or adhesively bonded to the film base body 30 inside the weakening line 31a. The tear-off tab 32 has an exposed tip 33 which may be grasped in order to tear open the prescored region. Incidentally, the sealing membrane 3 is also provided for closing the filling opening 22, and may be applied on the top side, or in special cases on the bottom side, of the lid 2.

With reference to FIGS. 1, 4, and 5, the removal tube 4 is fixedly attached to the container lid 2, and for this purpose a flanged edge 26 may extend around the outlet opening 21 in the container lid. The removal tube 4 may be formed from a sheet metal part, although production from plastic or cardboard is also possible. At its lower end the removal tube 4 has a shovel-shaped removal funnel 42 which has a lower bent edge 42a whose shape is adapted to the groove 16a in the base 12 of the container body 1.

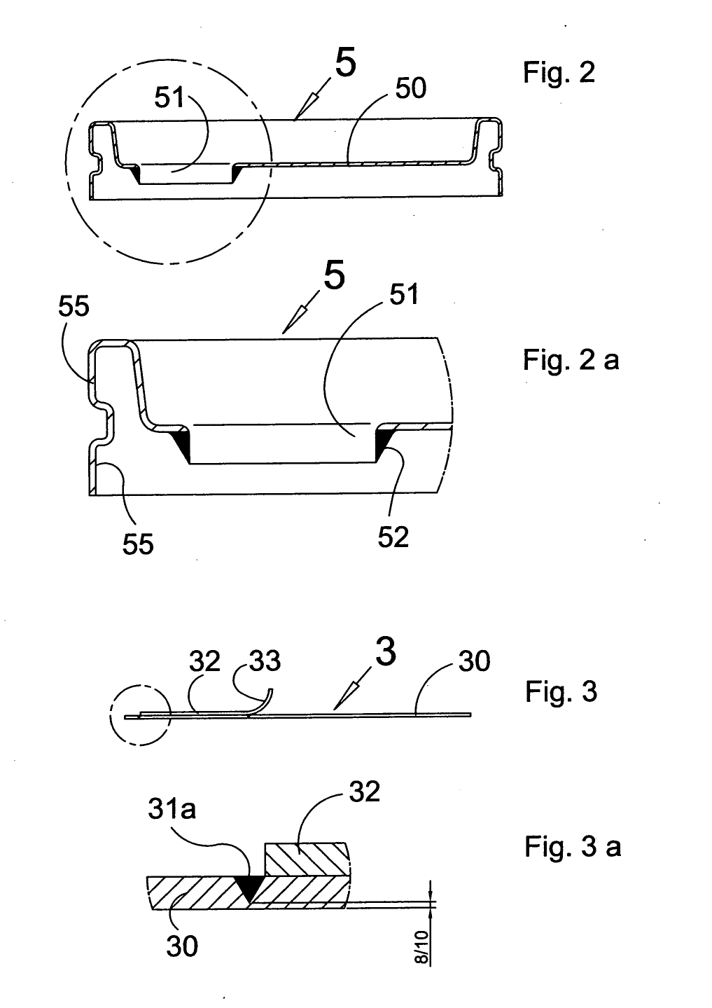

The rotary slide lid 5 (see FIGS. 1 and 2) is manufactured as a press-punched sheet metal part or a molded plastic part, and has a middle flat region 50 and a guide edge 55 which is designed for clipping onto the fold 15/25. A removal opening 51, present in the middle region 50 of the rotary slide lid 5, is surrounded by a sealing collar 52. The sealing collar 52 is made of elastic plastic, preferably thermoplastic elastomer (TPE), which is applied in a ring shape around the removal opening 51 at the underside of the rotary slide lid 5, and which has a lip-shaped cross section.

The dispenser is assembled from its individual parts as follows:

The container body 1 is provided. The removal tube 4 is fastened to the container lid 2, thus connecting the tube interior 41 to the outlet opening 21. The container lid 2 with the removal tube 4 fastened thereto is placed as an insert into the opening 10 in the container body 1, and the flanged edge 24 together with its sealing compound is brought into the opening 10 for sealing purposes. The removal tube 4 finds a natural hold at the container base 12 in which the lower edge 42a of the removal tube engages in the groove 16a at the container base. The folding edges 15 and 25 are then folded to form the interlocking ring 15/25.

The dispenser is prepared for filling with liquid or pourable goods in such a way that filling occurs through the filling opening 22. The sealing membrane 3 is then placed on the lid panel 20, with the tear-off tab 32 aligning with the outlet opening 21, and is sealed, thus closing the openings 21 and 22 in a gas-tight manner. The rotary slide lid 5 is then placed on the shoulder formed by the interlocking ring 15/25 in order to engage behind same. A rotary position of the rotary slide lid 5 is preferably selected such that the sealing collar 52 surrounds the tear-off tab and is aligned with the outlet opening 21. As the last step, the tamper-proof seal 6 may also be placed over the rotary slide lid 5.

For liquid or soft goods, the container body 1 may first be filled, after which the removal tube 4 is pushed into the filled material until it reaches the base 12 of the container. The container lid 2 together with the removal tube 4 is mounted on the container body 1. It is possible to attach the sealing membrane 3 to the underside of the lid 2 beforehand, and to use the edge region of the sealing membrane 3 for sealing between the container lid and the container body. In this embodiment the filling opening 22 is omitted, since filling is possible through the main opening 10.

The handling of the dispenser proceeds as follows:

After the tamper-proof seal 6 is removed, access is gained to the tip 33 of the tear-off tab 32, so that the tear-off opening 31 in the sealing membrane 3 may be exposed. The goods removal channel, which is formed by the interior 41 of the removal tube 4 and by the outlet opening 21 as well as the removal opening 51, is thus opened. The liquid, flowable, or pourable goods are removed by tipping and tilting the container body 1, as is known for sugar dispensers. A metered quantity of material is dispensed in each case.

By turning the rotary slide lid 5 having the removal opening 51 around the region of the lid panel 20, the outlet opening 21 is closed in a sealing manner by the sealing collar 52, so that the remaining goods in the dispenser remain protected from external effects.

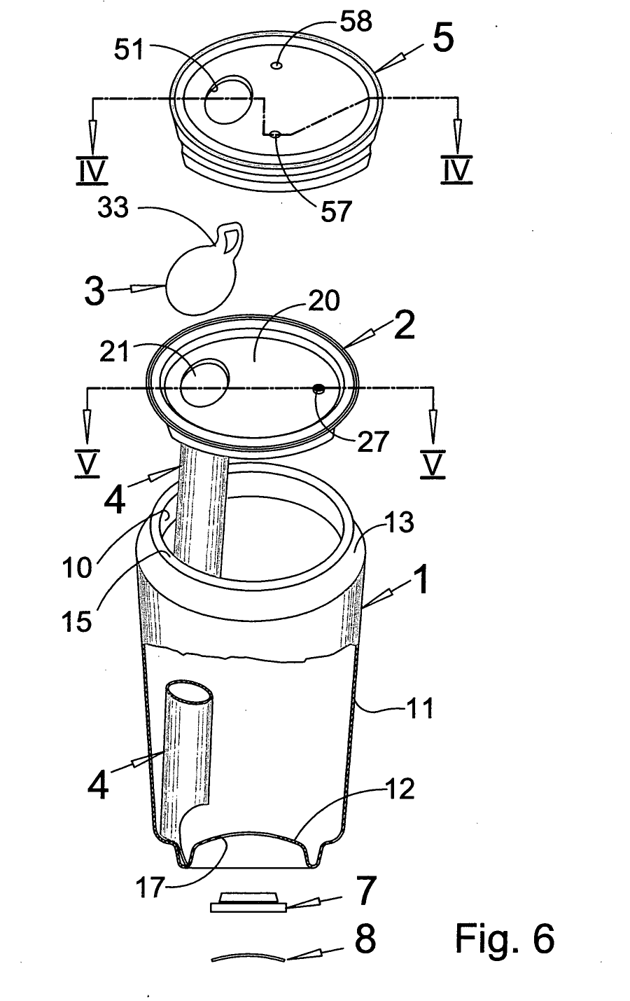

FIGS. 6 through 9 show a second embodiment of the dispenser. Parts which correspond to the first embodiment are denoted by the same reference numerals, and the descriptions in this regard apply, with the following modifications:
1. It is possible to fill the container body 1 through a filling opening 17 in the container base 12.
2. Stops 57 and 58 are provided at the rotary slide lid 5, and a stop 27 is provided at the container lid 2, so that the dispensing position and the hermetically sealed position may be conveniently adjusted.
3. The sealing membrane 3 has been modified.
4. An all-around seal is provided at the rotary slide lid 5.

A filling opening 17 is provided in the container base 12 for filling the container 1 in a reverse orientation compared to the illustration in FIG. 6 [sic; 1]. After filling, the opening 17 is closed by means of a closure in the form of a stopper 7 or a welded film 8.

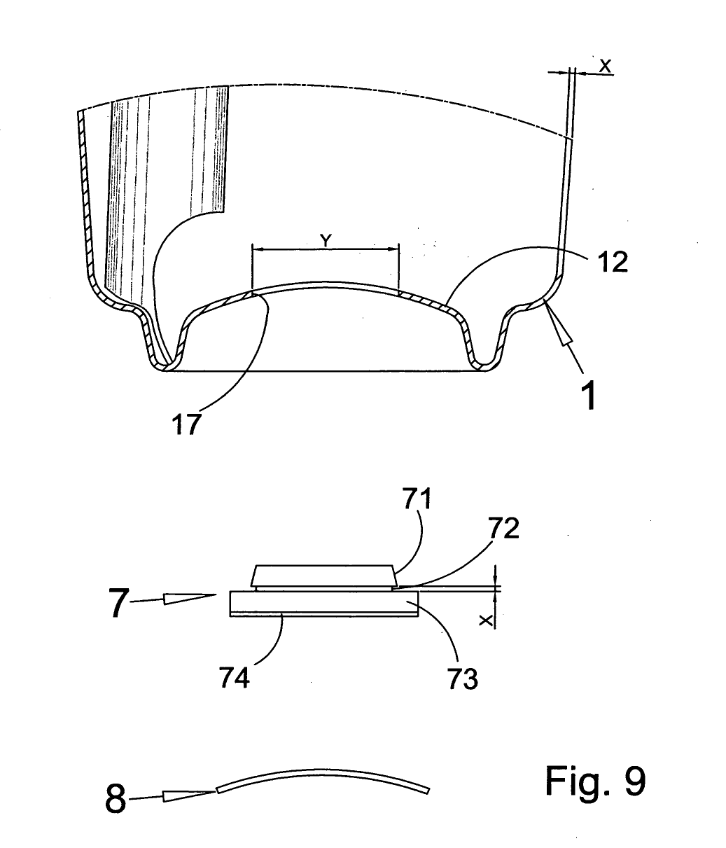

Reference is made to FIG. 9. The stopper 7 is made of plastic, for example LDPE, and has three sections: a conical insertion section 71, a groove 72, and a collar 73. The width of the filling opening 17 is y, which is also the dimension of the diameter of the stopper 7 at the groove 72. The sheet thickness of the container 1 is x, which is also the dimension of the width of the groove 72. To make the stopper more gas-tight, a barrier coating 74 may be applied to the stopper collar 73.

After the container 1 is filled, the tapering insertion section 71 of the stopper 7 is pushed into the filling opening 17 until the edge of the lid opening engages in the groove 72. The sealing effect results from the contact of the shoulder between the insertion section and the groove at the edge of the opening 17, and is increased by internal pressure in the container. Due to the curvature of the base 12, the container remains closed even when considerable internal pressure is present in the container, since the opening 17 becomes smaller when there is decreased curvature as the result of internal pressure. The stopper 7 is therefore also suitable for closing containers which have been filled with goods under gas pressure.

For cost reasons, containers having increasingly thinner walls are finding more frequent use. Such thin-walled containers may be reinforced by means of internal pressure. This option is useful when the container is filled with pourable bulk material. During the filling a dry inert gas such as liquid nitrogen is introduced, which after evaporation creates the stabilizing internal pressure and also provides a degree of oxidation protections.

Instead of a stopper, the filling opening 17 may also be closed using a pressure shock-resistant welded film 8. The welded film 8 is welded to the underside of the dome-shaped container base using a suitable welding method, for example ultrasonic welding or heating element welding. Welded films having sufficient barrier properties against gas or loss of flavor are used in the packaging of certain foods.

Since the filling opening 17 is attached to the container base 12 in the embodiment according to FIGS. 6 through 9, the filling opening 22 (FIG. 1) in the lid 2 may be omitted. Therefore, in the embodiment according to FIGS. 6 through 9 the sealing membrane 3 only needs to be large enough to cover the outlet opening 21. The sealing membrane is composed of a suitable pressure shock-resistant film which is applied by adhesive bonding or welding to the lid 2 above the outlet opening 21.

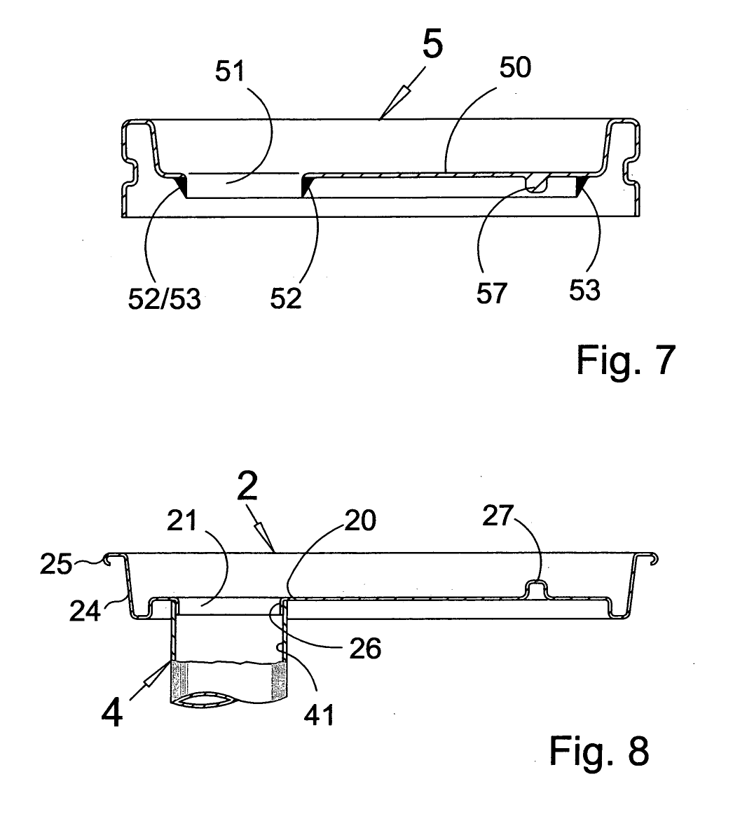

FIG. 7 shows a refinement of the rotary slide lid 5. To seal the outlet opening 21, the same as for the embodiment according to FIG. 1 a sealing collar 52 is provided around the removal opening 51. For better sealing of the lid during rotary motions, a further circular sealing collar 53 is provided which merges with the outer curvature of the ring seal 52, as indicated by reference numerals 52/53 in FIG. 7, and which with its larger remaining curvature rests or slides on the lid panel 20 outside the region of the outlet opening 21.

Stops 57 and 58 are also provided on the rotary slide lid 5, and a stop 27 is provided on the container lid 2, for more convenient handling of the rotary slide lid 5. The stops 27, 57, and 58 are situated at the same radial distance from the vertical axis of the container, and have an angular orientation such that in one stop position the removal opening 51 in the rotary slide lid 5 is aligned with the outlet opening 21 in the lid 2, while in the other stop position the removal opening 51 is outside the alignment with the outlet opening 21.

The advantage over containers which are hermetically sealable using a clamping lid is that the removal opening 51 is relatively small and the removal channel 41 is relatively long, so that the air exchange with the interior of the container during the removal process remains small compared to the known hermetically sealable containers, with the result that there is less loss of flavor and less penetration of atmospheric oxygen into the container. The rotary slide lid 5 also provides natural protection from improper removal of material, using a wet spoon, for example. A higher level of overall protection may be expected for sensitive container contents.

What is claimed is:

1. A dispenser comprising:
a container body (1) having a container wall (11), a container base (12), and an upper opening (10) surrounded by an edge of the upper opening;
a container lid (2) having a lid panel (20) with an outlet opening (21) and an edge of the container lid; and
a rotary slide lid (5) having a middle, flat region (50) and guide means to allow sealing means to become active between the flat region (50) and the outlet opening (21) in the closed position of the dispenser, and in the open position to allow goods to be removed through the aligned outlet opening (21) and removal opening (51);
wherein
a sealing membrane (3) for closing the outlet opening (21), and having a handle (33) for opening the outlet opening (21), is provided;
the edge of the upper opening (10) of the container body (1) is designed as a crimped edge (15), and the edge of the container lid (2) is designed as a crimped edge (25), which are connected to form an interlocking ring (15/25) for closing the container;
the guide means of the rotary slide lid (2) are formed by a guide edge (55) that engages beneath the interlocking ring (15/25) of the container;
the sealing means have a sealing collar (52) that surrounds the removal opening (51); and
a removal tube (4) is connected to the outlet opening (21) in the container lid (2), and has a removal funnel (42) near the container base (12) in order to dispense a portioned quantity of good when the open container is tilted.

2. The dispenser according to claim 1, wherein the interlocking ring (15/25) forms a detent stop and a rotary guide for the rotary slide lid (2).

3. The dispenser according to claim 1, wherein the container lid (2) is designed as a circular, press-punched sheet metal part having an embedded lid panel (20) and having a flanged edge (24) that projects upwardly from same, to which a sealing compound is applied in order to make the connection of the container lid (2) and the container body (1) gas-tight.

4. The dispenser according to claim 1, wherein the container lid (2) has a filling opening (22) that is closed by the sealing membrane (3) after the container body (1) is filled.

5. The dispenser according to claim 1, wherein the container base (12) is curved toward the interior of the container, and has a filling opening (17) that is to be closed by means of a closure (7; 8) after filling.

6. The dispenser according to claim 1, wherein the removal tube (4) extends along the container wall (11) and near same, and the removal funnel (42) opens in the direction of the center of the container and is locked to the container base (12) in a positive-fit manner.

7. The dispenser according to claim 6, wherein the container base (12) has an integrally molded, ring-shaped protrusion (16) at the edge, which inside the container forms a guide groove (16a) for the lower end (42a) of the removal funnel (42), and on the outside of the container forms a standing and stacking surface.

8. The dispenser according to claim 1, wherein the sealing membrane (3) has a film base body (30), made of aluminum or plastic, that conforms to the shape of the lid panel (20) and that is provided with a tear-off opening (31), and also includes a sealing layer for making a sealing connection with the lid (21), and a tear-off tab (32) that is attached to the sealing membrane above the tear-off opening (31).

9. The dispenser according to claim 1, wherein the rotary slide lid (5) is clipped onto the interlocking ring (15/25) of the closed container body (1), and is rotatably held on the interlocking ring (15/25) to allow the rotation into the closed position of the dispenser in which the sealing collar (52) is situated above the lid panel (20), and into the removal position in which the sealing collar (52) is situated above the outlet opening (21) in the container lid (2).

10. The dispenser according to claim 9, wherein the sealing collar (52) of the rotary slide lid forms a ring around the removal opening (51) in the rotary slide (5), and has a lipped-shaped cross section.

11. The dispenser according to claim 1, wherein a second sealing collar (53) having a lip-shaped cross section is provided on the rotary slide lid (5) that has a shared curvature (52/53) with the first sealing collar (52), and that encloses the remainder of the first sealing collar (52) in a curvature that surrounds the lid panel (20) outside the region of the outlet opening (21).

12. The dispenser according to claim 9, wherein the container lid (2) has a stop (27), and the rotary slide lid (5) has further stops (57, 58), which cooperate duration rotation of the rotary slide lid in such a way that in one stop position the removal opening (51) aligns with the outlet opening (21), and in the other stop position even partial alignment is reliably prevented in order to seal the outlet opening (21) as a result of the middle region (50) of the rotary slide lid (5) and of the sealing collar (52).

13. The dispenser according to claim 1, wherein the closure for the filling opening (17) in the container base (12) comprises a stopper having an insertion section (71), a groove (72), and a flange section (73).

14. The dispenser according to claim 1, wherein the closure includes a pressure shock-resistant film (8) that is welded to the container base (12).

15. A method for handling a dispenser that is filled with goods at the factory under gas- and aroma-tight conditions and that has the technical features according to claim 1 the method comprising:
a) rotating the rotary slide lid (5), with the removal opening (51) in alignment with the closed outlet opening (21);
b) removing the sealing membrane (3) above the outlet opening (21);
c) tilting the dispenser, with the removal opening (51) above a collection container for the goods and dispensing a portioned quantity of goods;
d) tilting the dispenser back into the upright position;
e) rotating the rotary slide lid (5), with the removal opening (51) out of alignment with the outlet opening (21), so that the middle, flat region (50) of the rotary slide lid (5) covers the outlet opening (21) and ends the air exchange with the interior of the removal tube (4); and
f) upon each subsequent removal of goods, i) rotating the rotary slide lid (5) having the removal opening (51) into alignment with the outlet opening (21), and ii) repeating steps c) through e).
